(19) United States
(12) Patent Application Publication
(10) Pub. No.: US 2003/0017287 A1
(43) Pub. Date: Jan. 23, 2003

(54) Disk container

(75) Inventors: Kazuhiro Niitsuma, Kanagawa (JP); Shinichi Kato, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/173,831

(22) Filed: Jun. 19, 2002

(30) Foreign Application Priority Data
Jun. 19, 2001 (JP) 2001-185242
Jun. 20, 2001 (JP) 2001-186755
Sep. 3, 2001 (JP) 2001-265967

(51) Int. Cl. B32B 1/02

(52) U.S. Cl. 428/35.2

(57) ABSTRACT

A disk container for accommodating a disk recording medium in the present invention comprises specified material having an antifungal function.

### BACKGROUND OF THE INVENTION

1. Field of the Invention

The present invention relates to a disk container that accommodates a disk recording medium such as optical disks, magneto-optical disks, etc., and in particular relates to a technique of preventing fungi (mold) growth.

2. Description of the Related Art

In these years, enhancement of recording capacity is intended for optical disks and the like; in contrast to the fact that the recording capacity of CD's (compact disks) is 650 MB, DVD's (digital video disks), which have a variety of configurations, have a recording capacity of 4.7 GB for the single side, and those of a dual layer type have a further increased recording capacity of 8.5 GB for the single side. Along with such changes, in comparison to the 1.33 μm track pitch of CD's, the track pitch of DVD's is 0.74 mm in the standard format. Accordingly, DVD's have a recording configuration in which pits are closely packed at a high density also along the track direction. Hence, DVD's are so exactingly designed as to suppress cross talks by decreasing the deviation and the maximum variation of track pitch in order to meet the recording capacity of DVD's.

Furthermore, in contrast to the fact that the wavelength of the light source used for the playback of CD's is of a near-infrared laser light (780 nm), a red-colored laser light (650 nm) is used for DVD's. Recently, those which conduct recording and playback using a blue laser (around 425 nm) are being developed. By making the wavelength of the light source short, one can reduce the spot diameter of the laser beam from the optical pickup, thus enabling a still narrower pitch for the recording pit.

Alternatively, apart from making the wavelength of light shorter, adoption of a lens with a large numerical aperture can achieve narrow pitches. For example, it is in practical application to use an object lens and an SIL (Solid Immersion Lens) composite lens that consists of a glass sphere part of which is cut out to form a flat plane specifically in order to raise the numerical aperture.

The disk-formed recording media on which recording is made at such high densities are kept by being accommodated in, for example, a disk-keeping bag for the purpose of protecting the disk surface from foreign matters and damaging. As such disk-keeping bags, those in which a non-woven fabric is provided at the inner surface of a bag made of a resinous sheet, etc. fabricated into the form of bag are used extensively. The non-woven fabric acts, due to its pliability, to protect the recording surface of the disk recording medium and prevent it from receiving damages.

In many cases, these disk-formed recording media are accommodated and kept in a plastic case when they are not in use. In the plastic case, in general, index cards (title cards) showing the content recorded in the media, etc., and other printed matters made of paper are also accommodated.

However, in cases where a disk container such as a disk-keeping bag and a case for accommodating a disk, that accommodates a disk recording medium, is kept particularly under a high-humidity atmosphere over a long period of time, mold sometimes happens to grow since oil, foreign matters and the like adhering at the portions in the disk surface that were touched with human hands serve as nutrients for the mold. Further, in cases where mold grows at some portions of the disk-keeping bag, transfer of the mold onto the disk surface essentially proceeds. And, once mold grows in the disk surface, not only recording and playback both are hindered, but also there arise problems such as a further promotion of foreign matter adhesion during the handling of the disk recording medium, etc.

In addition to these problems, there is a trend that the distance from the disk recording medium to the optical pickup becomes short in the recording and playback operations for DVD's whereby use is made of a light source of a shorter wavelength and/or an SIL composite lens with a large numerical aperture for the optical pickup device. Under such a trend, information recording and playback sometimes become difficult by the presence of such mold, damages or foreign matters adhering to the disk surface that have caused no special problems for the conventional CD's (including CD-ROM's, CD-R's (-R standing for -Recordable), CD-RW's (-RW standing for -ReWritable), etc.). This can be explained as follows. Though a laser beam is focused through a 1.2 mm thick substrate for CD's, the beam is focused through a thinner substrate of only 0.6 mm thickness for DVD's. Accordingly, even when the damage or foreign matter is of the same size, the ratio of the dimension of the foreign matter to that of the beam spot is overwhelmingly larger for DVD's, which fact acts, together with the raise-up of recording density as described hereinabove, to readily cause errors.

Moreover, there has been a concern that adhering foreign matters collide against the pickup lens arranged close to the disk surface during the rotation of the disk recording medium to either damage the device or cause the disk recording medium to break.

In particular, in the case where a disk recording medium bearing mold growing at its surface is placed for use in a playback apparatus, the situation is serious. That is, in addition to the above-cited troubles, badly concerned is mold contamination and infection to some parts of the apparatus such as the pickup lens, etc. while the disk recording medium is inserted in the apparatus. Once the apparatus is infected with mold, the mold may propagate in an accelerated manner when preferable conditions including an appropriate humidity and temperature, air supply, etc. happen to be fulfilled whereby the multiplied mold may well cause a serious damage not only in the disk recording medium but the apparatus itself.

Further, if a disk recording medium accommodated in a disk-keeping bag as a commercial product or attachment suffers mold occurrence thereon, the commercial value is deteriorated and may spoil user confidence.

### SUMMARY OF THE INVENTION

The present invention has been devised in view of such conventional situations, and has an object of providing a highly reliable disk container for a disk recording medium, said disk container being characterized by preventing fungi (mold) growth in the disk recording medium and mold infection to other portions thereof.

The object of the invention is accomplished with a disk container as mentioned below.

(1) A disk container for accommodating a disk recording medium (a first embodiment), wherein at least one of (1) a non-woven fabric below and (2) a non-woven fabric below is provided at least on the interior surface of the disk container, the interior surface being at the side that comes into contact with the recording plane of the disk recording medium:

a non-woven fabric (1): a non-woven fabric impregnated with a solution containing C₄H₉NHCOOCH₂C≡CI (3-iodo-2-propynyl-N-butylcarbamate) in such a manner that the non-woven fabric contains C₄H₉NHCOOCH₂C≡CI in an amount of from 0.1 to 0.9 wt %,

a non-woven fabric (2): a non-woven fabric containing an acrylic fiber in an amount of 50 wt % or more.

(2) A disk container for accommodating a disk recording medium, which comprises an acrylic-based resin (a second embodiment).

(3) The disk container for accommodating a disk recording medium according to the item (1) or (2), wherein the disc container is a bag for keeping disk.

(4) The disk container for accommodating a disk recording medium according to the item (2), which comprises: a resin layer containing the acrylic-based resin; and a resin layer containing a resin other than the acrylic-based resin.

(5) The disk container for accommodating a disk recording medium according to the item (2), wherein the angular portion of the component including the resin layer containing the acrylic-based resin are rounded out.

(6) The disk container for accommodating a disk recording medium according to the item (2), which comprises: a case body; a lid; and a tray fitted in the case body, wherein the tray contains the acrylic-based resin.

(7) A disk container for accommodating a disk recording medium, which comprises a synthetic resin mixed with an antifungal agent (a third embodiment).

(8) The disk container for accommodating a disk recording medium according to the item (7), which comprises: a resin layer containing a acrylic-based resin; and a resin layer containing the antifungal agent.

### BRIEF DESCRIPTION OF THE DRAWINGS

FIG. 1 is a drawing illustrating the configuration of the disk container (the disk-keeping bag) in a first and third practical embodiments of the invention.

FIG. 2 is the cross-sectional view at section A-A in FIG. 1.

FIG. 3 is the cross-sectional view showing a disk-keeping bag of a second and fourth practical embodiments.

FIG. 4 is an oblique perspective view showing a fifth practical embodiment of the invention.

FIG. 5 is a cross-sectional view showing the principal portion of a sixth practical embodiment of the invention.

FIG. 6 is an oblique perspective view showing the principal portion of a seventh practical embodiment of the invention.

FIG. 7 is an oblique perspective view showing the principal portion of an eighth practical embodiment of the invention.

FIG. 8 is an oblique perspective view showing a modified example of the invention.

### DESCRIPTION OF THE REFERENCE NUMERALS AND SIGNS

10 Disk recording medium

12 Resin sheet

14 Non-woven fabric

100, 200 Disk-keeping bag

1, 11, 20, 30, 40 Disk recording medium-keeping case

2 Case body

3 Tray

4 Lid

5 Disk recording medium

### DETAILED DESCRIPTION OF THE INVENTION

The disk container of a first embodiment of the present invention can prevent mold growth in the disk container, in particular in the non-woven fabric without contaminating the disk surface with the solution to be described below, and thus mold transfer to and mold growth in the disk plane owing to the fact that the non-woven fabric provided in the inside of the container is impregnated with a solution containing 3-iodo-2-propynyl-N-butylcarbamate so as to contain this compound at a content of from 0.1 to 0.9 wt %. Thanks to such a mechanism, in the operation of recording and playback for the accommodated disk recording medium, mold infection to the optical pickup belonging to the recording/playback apparatus can be prevented, and at the same time a fungicidal effect for the apparatus can be attained.

Also, the disk container of a first embodiment of the present invention can prevent mold infection to and mold growth in the disk surface because the fungicidal effect inherent to acrylic fibers propagates over the entire disk container due to the fact that the non-woven fabric lined in the bag contains 50 wt % or more of an acrylic fiber. Thanks to such a mechanism, in the operation of recording and playback for the accommodated disk recording medium, mold infection to the optical pickup belonging to the recording/playback apparatus can be prevented, and at the same time a similar fungicidal effect for the apparatus can be attained.

Alternatively, the disk container of a second embodiment of the present invention is characterized by comprising an acrylic-based resin (in particularly, a sheet of an acrylic-based resin), in which case, due to the fungicidal effect inherent to the acrylic-based resin, a fungicidal effect for the disk recording medium is attained. And, by the joint use of the above-described non-woven fabric, the fungicidal effect is enhanced to a more reliable level.

The disk container of a third embodiment of the present invention is characterized by comprising a synthetic resin mixed with an antifungal agent. All the resinous components constituting the disk container such as the disk recording media-keeping case may be made of a synthetic resin mixed with an antifungal agent, or part of the resinous components may be made of a synthetic resin mixed with an antifungal agent.

A antifungal agent can be mixed (blended) into a synthetic resin by, for example, adding the antifungal agent during the melting operation of the pellet of the synthetic resin. By such processing, an antimicrobial and antifungal effect can be exhibited over a long period of time.

As an example, a disk recording media-keeping container can be fabricated with a comparatively inexpensive polypropylene or polystyrene mixed with an antifungal agent. Polypropylene, which is highly flexible, can enhance the sealing property of the disk recording media-keeping container.

As the antifungal agent, one can mention, for example, zeolite (containing an antibacterial metal ion such as silver, cupper, zinc, etc.), chitosan, hinokitiol, etc. As other antifungal agents, silver/silica gel-based antibacterial agents, diphenyl ether-based ones, silicone quaternary ammonium, etc. are mentioned.

According to the disk container of a third embodiment such as those described above, there is no need of equipping the container later with separate fungicidal means, or conducting a fungicidal treatment afterwards, since an antifungal agent is incorporated in the synthetic resin composing the disk recording media-keeping container. Further, owing to the fact that the antifungal agent is blended in the synthetic resin in advance, the antifungal agent can be imparted to every pre-determined portion of the disk recording media-keeping container thoroughly and uniformly. Hence a superior fungicidal effect is achieved.

Moreover, the disk container of a third embodiment of the invention mentioned above is preferably a disk recording media-keeping container which is characterized in that a resinous component of the disk-formed recording media-keeping container has a dual layer structure comprising a resin layer containing an acrylic-based resin and a resin layer containing another synthetic resin.

In such a case, all the resinous components constituting the disk recording media-keeping container may have a dual layer structure comprising the resin layer containing an acrylic-based resin and the resin layer containing another synthetic resin, or part of the resinous components may has a dual layer structure comprising the resin layer containing an acrylic-based resin and the resin layer containing another synthetic resin.

It is preferable to arrange the resin layer containing the other synthetic resin on the resin layer containing the acrylic-based resin so as to cover the latter with the former. Such a dual layer structure can be obtained, for example, with use of a two-color injection molding machine or different materials injection molding machine. Alternatively, such a dual layer structure is realized by attaching a separately prepared component made of an acrylic-based resin to the synthetic resin plate constituting the container.

Though acrylic-based resins have a fungicidal function, they are poor in mechanical strength (i.e., fragile) and expensive. By adopting the above-described dual layer structure made of an acrylic-based resin and another synthetic resin, one can not only secure the required strength, but also reduce the cost via the suppression of the use amount of the acrylic-based resin. Then, owing to the fungicidal activity of the acrylic-based resin, mold growth can be powerfully prevented.

The disk container of the third embodiment of the invention mentioned above is preferably a disk recording media-keeping container which is characterized in that the resinous component of the disk recording media-keeping container includes an acrylic-based resin and that the angular portions (edges) of the component including the acrylic-based resin are rounded out.

All the resinous components constituting the disk recording media-keeping container may be made of an acrylic-based resin, or part of the resinous components may be made of an acrylic-based resin. In such structures, owing to the fungicidal activity of the acrylic-based resin, mold growth can be powerfully prevented. By eliminating sharp edges of the constituent components made of the acrylic-based resin, fracture damages due to stress concentration, etc. become difficult to occur.

Moreover, the disk container of the third embodiment of the invention mentioned above is preferably a disk recording media-keeping container comprising a case body, a lid and a tray fitted in said case body, wherein said tray is made of an acrylic-based resin.

According to such a configuration, mold growth can be suppressed by the tray even when the case body and the lid are made of a synthetic resin exhibiting no fungicidal activity. The tray made of an acrylic-based resin, which is fitted in the case body, is protected by the case body, and thus does not suffer from fracture.

In the following, some practical embodiments of the disk container related to the invention are described in detail with reference to the drawings.

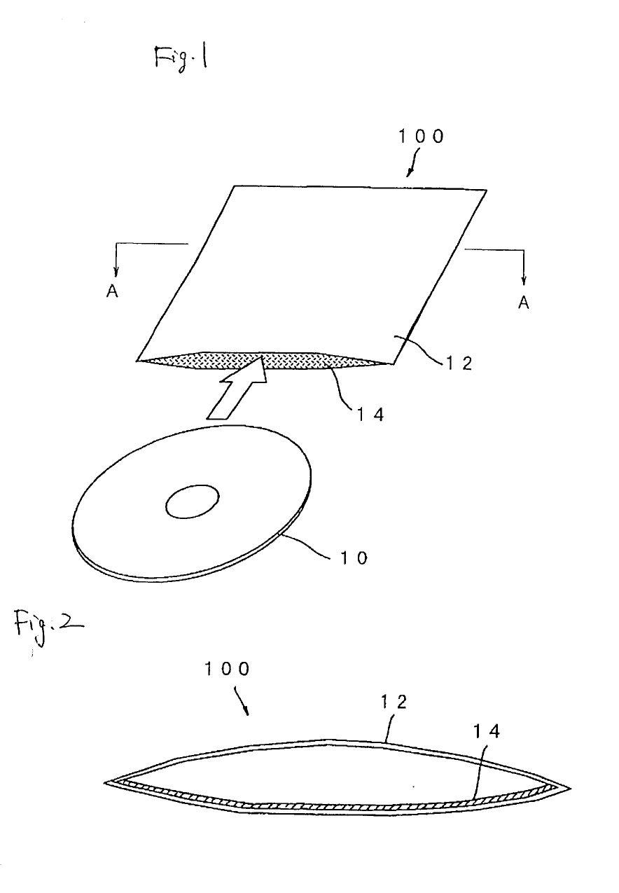

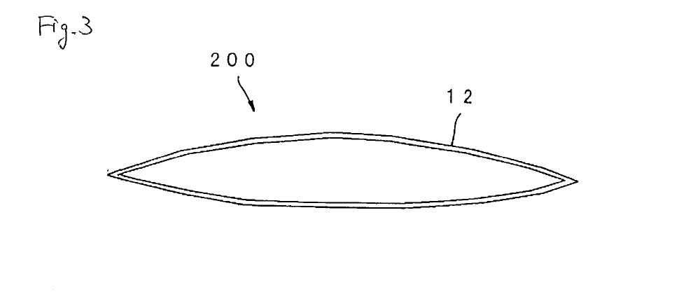

FIG. 1 is an example showing the shape of a first practical embodiment of the invention (a disk-keeping bag, sometimes called envelope bag, too) according to the invention, and FIG. 2 is a cross-sectional view showing section A-A in FIG. 1.

The disk-keeping bag 100 as the present practical embodiment mainly comprises a resinous sheet 12 which has been fabricated in the form of bag, and accommodates a disk-formed recording medium 10 such as, for example, DVD's, etc. on which information can be recorded at a high density. This disk-keeping bag 100 is provided with a non-woven fabric 14 at least on the inner surface of the bag that comes into contact with the recording plane of the disk-formed recording medium 10.

The resinous sheet 12, for which use is made of a material such as polyester, polypropylene, nylon, polyethylene, PET (poly(ethylene terephthalate), etc., is fabricated in the form of bag in which one side edge is left open so as to enable the accommodation of the disk-formed recording medium 10. In this practical embodiment, a non-woven fabric 14 is provided on the inner surface that comes into contact with the recording plane of the disk-formed recording medium 10 as is illustrated in FIG. 2.

As the non-woven fabric 14, rayon/polyester mixed fibers, etc. that exhibit a relatively high moisture absorption ratio are usually employed. But when such fabrics are used under highly humid conditions, mold grows in the non-woven fabric, and is transferred as a foreign matter onto the accommodated disk-formed recording medium 10. Accordingly, in the present practical embodiment, mold growth is prevented by impregnating the non-woven fabric with an antifungal agent (a fungicide) at a pre-determined content whereby no adverse effect is exerted on the disk-formed recording medium to be accommodated.

As the fungicide, those mainly comprising 3-iodo-2-propynyl-N-butylcarbamate are particularly suited. This type of compound has a vaporizing property of being discharged gradually into the air; thus the fungicidal effect lasts over a period of time as long as 2 to 3 years or more. This compound can be represented by the following chemical formula.

C₄H₉NHCOOCH₂C≡CI

At the process of impregnating a non-woven fabric with a solution containing this compound, however, the solution happens to ooze toward the surface of the non-woven fabric to sometimes contaminate the disk surface if the impregnated amount is too large. Inversely, if the amount is too small, a sufficient level of fungicidal effect is not attained. In general, in such process of fungicide incorporation, an amount to be incorporated is determined from empirical rules. However, the amount to be incorporated varies depending on a number of conditions including the shape factors such as size and thickness, the material type and the application purpose of the object to which the fungicide is incorporated. Accordingly, in the operation of fungicide incorporation, there has been a complication of trained experts' establishing the addition amount corresponding to each object to which the fungicide is added for each operation.

Therefore, in the present practical embodiment, the manufacturing operation for disk-keeping bags are simplified by quantitatively clarifying the necessary addition amount, and impregnating the compound into the non-woven fabric in the most appropriate addition amount established by the above clarification.

Specifically, the above-cited compound is impregnated into the non-woven fabric in a ratio of from 0.1 to 0.9 wt %. It has been verified that, by the impregnation within this content range, a necessary and sufficient fungicidal effect is exerted, and that the quality changes in the accommodated disk-formed recording medium that may be caused by the adhesion of the fungicide and the ingredient of the fungicide, etc. can be reliably prevented.

The non-woven fabric 14 can be prepared by any process selected from the thermal bonding process, the latex process (for the binder type), the water jet process, etc. The non-woven fabric may further be prepared by combining these enumerated processes.

Here, the thermal bonding process is a method in which cotton, etc. having a low melting point is blended in the fibers, and the low melting point material is melted by means of a hot press or hot air to fix and bond the fibers together. This method can prepare a non-woven fabric provided with a high pliability. The latex process is a method of bonding fibers together with use of a binder, and gives rise to a mechanically strong non-woven fabric. The water jet process consists of forming a web by using a carding machine that is used as, for example, a cotton mill machine; then subjecting the web thus prepared to high-pressure, fine water jets that run in upward and downward directions to cause the web fibers to be entangled by the hydraulic pressure; and thereafter drying the product. Since the water jets carry away foreign matters and impurities, a sanitary non-woven fabric results.

As the method of impregnating a fungicide in the above-cited non-woven fabric 14, one can employ any of known methods including one based on spraying, one based on ordinary over-coating, printing, etc.

In such a way, according to the disk-keeping bag 100 of the present embodiment, the disk-keeping bag 100 itself is provided with a fungicidal function by maintaining an environment under which mold is difficult to propagate owing to the impregnation of a fungicide into the non-woven fabric lined inside the bag. By such a mechanism, mold transfer onto the accommodated disk-formed recording medium 10 and mold growth from the disk-formed recording medium 10 can be suppressed. Therefore, the recording and playback operations are always maintained normal even when the disk-formed recording medium 10 operates in a high-density recording mode, and simultaneously mold infection to the optical pickup belonging to the playback apparatus, etc. can be prevented. Further, in cases where a disk-formed recording medium is accommodated in a disk-keeping bag as a commercial product, an attachment, etc., the accommodated disk never suffers mold growing thereon. Hence, the commercial value thereof is not deteriorated, and user confidence is not spoiled at all.

To make sure, the non-woven fabric 14 may be provided not only on the inner side of the disk-keeping bag where the bag comes into contact with the recording plane of the disk-formed recording medium 10, but on both inner sides of the bag. In such cases, all the surfaces of the disk-formed recording medium 10 are protected, and an enhanced fungicidal effect can be expected, too.

Next, a second practical embodiment of the disk container (the disk-keeping bag) related to the invention will be described.

The disk-keeping bag 200 of the present embodiment, which is shown at the section A-A in FIG. 3 similarly to FIG. 2, consists of a resinous sheet 12 that is fabricated in the form of bag.

The resinous sheet 12, which has been prepared by blending the above-cited fungicide into the resin itself, is provided with a fungicidal property in itself. As the addition amount of the fungicide, 0.2 to 0.74 wt % is preferred.

According to the disk-keeping bag 200 of this type, not only the processing cost and material cost can be curtailed by saving the non-woven fabric but using the resinous sheet 12 alone, but also a fungicidal effect equivalent to that in the first practical embodiment can be attained.

Further, the resinous sheet containing the fungicide according to the present embodiment may be used as the resinous sheet for the disk-keeping bag of the first embodiment described above. With such a construction, the fungicidal effect is further enhanced.

In each embodiment described heretofore, the descriptions have been made with a DVD as an example of disk-formed recording media with which high-density information recording is possible. But, the disk-keeping bag according to the invention is not limited to such DVD applications but can be applied to CD-keeping bags as well.

With regard to a third practical embodiment, in cases where an acrylic fiber is used, mold does not grow under such conditions. Although the reason is not clear, it is assumed that the remaining acrylic acid monomer contained in the acrylic fiber contributes to the fungicidal effect. Hence, in the present practical embodiment, the non-woven fabric is formulated so that, among the fibers used in the non-woven fabric, an acrylic fiber occupies 50% or more of the total amount.

Moreover, the non-woven fabric 14, which may consist solely of an acrylic fiber, may comprise mixtures with a rayon fiber, nylon fiber, polyester fiber, polypropylene fiber, etc., or may assume a layered structure with use of these fibers. In the bags adopting a layered structure, at least the layer that comes into contact with the recording plane of the disk-formed recording medium 10 (i.e., the innermost layer of the bag) is formulated to consist of a non-woven fabric containing 50% or more of an acrylic fiber.

According to the disk-keeping bag 100 of the present embodiment, the disk-keeping bag 100 itself is provided with a fungicidal function owing to the use of an acrylic fiber for the non-woven fabric 14, and hence mold transfer onto the accommodated disk-formed recording medium 10 and mold growth from the disk-formed recording medium 10 can be suppressed. Owing to such a mechanism, the recording and playback operations are always maintained normal even when the disk-formed recording medium 10 is of a high density recording configuration, and simultaneously mold infection to the optical pickup belonging to the playback apparatus, etc. can be prevented. Further, in cases where a disk-formed recording medium is accommodated in a disk-keeping bag as a commercial product, an attachment, etc., the accommodated disk never suffers mold growing thereon. Hence, the commercial value thereof is not deteriorated, and user confidence is not spoiled at all.

To make sure, the non-woven fabric 14 may be provided not only on the inner side of the disk-keeping bag where the bag comes into contact with the recording plane of the disk-formed recording medium 10, but on both of the inner sides of the bag. In such cases, the entire surface of the disk-formed recording medium 10 is protected. At the same time, an enhanced fungicidal effect can be enhanced by an increased amount of the acrylic fiber used in a single disk-keeping bag.

Further, the resinous sheet 12 may be made of an acrylic-based resin whereby a more reliable fungicidal effect is attained on the upper and lower surfaces of the disk-formed recording medium 10.

Next, a fourth practical embodiment of the disk-keeping bag related to the invention will be described.

The disk-keeping bag 200 of the present embodiment, which is shown by section A-A in FIG. 3 in a similar manner as in FIG. 2, consists of a resinous sheet 12 made of an acrylic-based resin that is fabricated in the form of bag.

According to the disk-keeping bag 200 for this case, the material cost can be curtailed by using no non-woven fabric but just the resinous sheet 12 of an acrylic resin. Although, the atmospheric condition under which a desirable fungicidal effect is attained is restricted in this case, there exist situations where a fungicidal effect of such levels suffices depending on the use purpose of the disk-keeping bag 200. Under such situations, one can attain a necessary and minimal fungicidal effect with a cost reduced as much as possible.

In each embodiment described heretofore, the descriptions have been made with a DVD as an example of disk-formed recording media with which high-density information recording is possible. But, the disk-keeping bag according to the invention is not limited to such DVD applications but can be applied to CD-keeping bags as well.

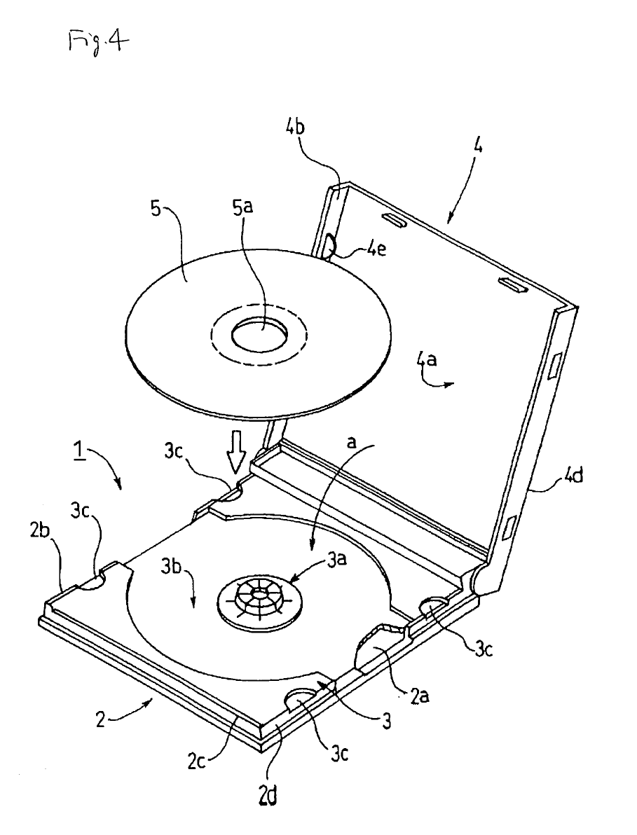

The disk container (the disk-formed recording media-keeping case) 1 as a fifth practical embodiment shown in FIG. 4 is roughly composed of a case body 2 fabricated in the form of a shallow box, a tray 3 fitted in the case body 2 and a lid 4 that is attached to the case body 2 in a freely rotating manner.

The case body 2 comprises a flat board part 2a, and frames 2b, 2c and 2d arranged in the outer periphery of the lat board part 2a. And a tray 3 is fitted inside the frames 2b to 2d. The tray 3 comprises a catching part 3a that catches a disk-formed recording medium 5 in a readily catching and detachable manner, and an accommodation part 3b fabricated in the form of depression to accept the disk-formed recording medium 5. The lid 4 comprises a flat board part 4a and frames 4b and 4d arranged at the both ends of the flat board part 4a. At the inner sides of each frame 4b or 4d, two stopper nails 4e are provided. By means of the stopper nails 4e, an index card or paper-made printed matters both not shown in the figure is held so as to face the inner surface of the flat board part 4a of the lid 4.

To accommodate the disk-formed recording medium 5 in the disk-formed recording media-keeping case 1, the disk-formed recording medium 5 is placed into the accommodation part 3b from the state shown in the figure, and fixed by fitting the catching part 3a into the central opening 5a of the disk-formed recording medium 5. Then, by rotating the lid 4 in the direction of the arrow a, the lid 4 is placed on the case body 2. In this operation, the stopping nails 4e equipped in the lid 4 are put into the depressions 3c formed at the four corners of the tray 3.

In the disk-formed recording media-keeping case 1, the case body 2 and the lid 4 are made of polypropylene or polystyrene kneaded with a fungicide.

Further, the tray 3 is made of a colored acrylic-based resin.

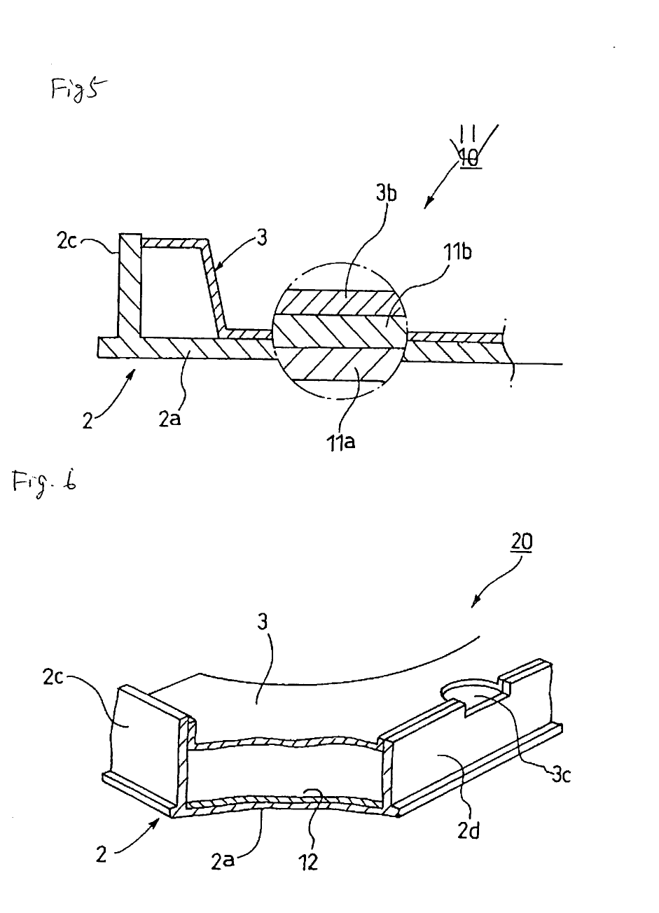

FIG. 5 is a cross-sectional view of a disk container (a disk recording media-keeping case) 10 as a sixth embodiment. In the figure, the principal portion is magnified. Just to make sure, in the embodiment to be described below, any part, etc. that has a structure or function similar to that of the part already described is assigned the same sign or an equivalent sign in the figure to simplify or save the explanation thereon.

In the present embodiment, the flat board part 2a of the case body 2 takes a dual layer structure. As is shown in the magnified portion of FIG. 5, the layer 11a arranged at the outer side of the case body 2 is made of polypropylene or polystyrene, and the layer 11b arranged at the inner side is made of an acrylic-based resin. Such a dual layer structure can be produced, for example, with use of a two-color injection-molding machine or different materials injection molding machine.

It is also possible to make the tray 3 assume a dual layer structure. That is, the layer 3b arranged at the inner side of the tray 3 (the side facing the disk-formed recording medium) is made of an acrylic-based resin, and the layer 11b arranged at the outer side is made of polypropylene or polystyrene. Alternatively, the inner side layer 3b of the tray 3 may be made of polypropylene or polystyrene, and the outer side layer 11b may be made of an acrylic-based resin.

FIG. 6 is an oblique perspective view of the principal portion of a disk container (a disk recording media-keeping case) 20 as a seventh practical embodiment. In the figure, part of the case is cut off.

In this embodiment, a board member 12 made of an acrylic-based resin is bonded to the inner side of the flat board part 2a of the case body 2.

Though not shown in the figure, a board member made of an acrylic-based resin may be bonded to the inner side of the flat board part of the lid.

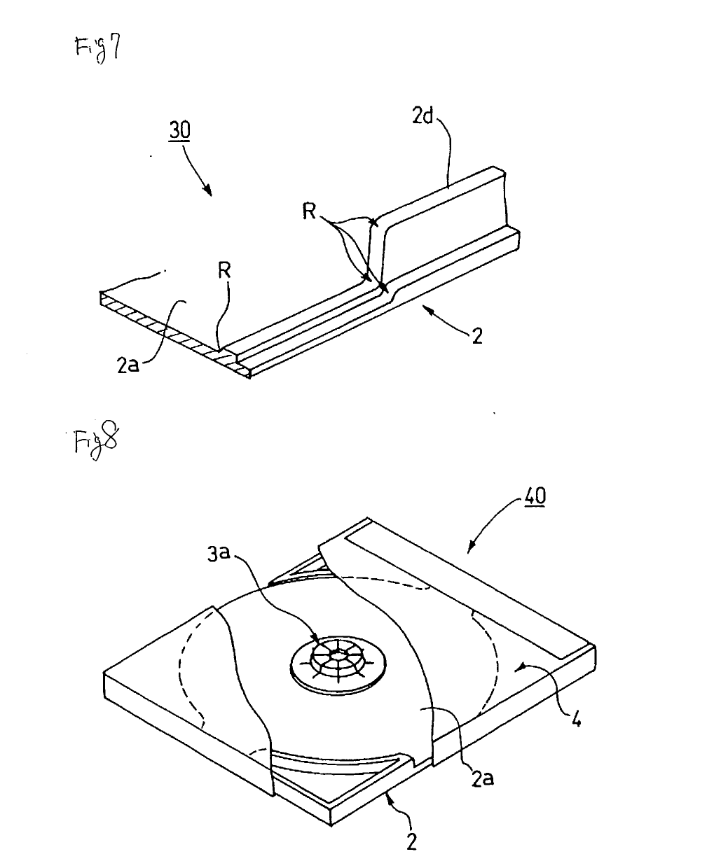

FIG. 7 is an oblique perspective view of the principal portion of a disk container (a disk recording media-keeping case) 30 as an eighth embodiment.

In the present embodiment, the case body 2 is made of an acrylic-based resin. And, the angular parts (edges) of the frame 2d in the case body 2 and the angular parts where the frame 2d crosses with the flat board part 2a are chamfered to give rounded shapes R.

To make sure, the invention is not restricted to the embodiments described heretofore, but appropriate modifications, improvements, etc. are possible.

For example, the invention can be applied to the disk-formed recording media-keeping case 40 of a structure containing no tray as is shown in FIG. 8. In this case, in the flat board part 2a of the case body 2, there are fabricated a catching part 3a to catch and hold the disk-formed recording medium and an accommodation part to accommodate the disk-formed recording medium in an integrated manner.

Further, the above-described embodiments may be appropriately combined together whereby a high fungicidal effect and mechanical strength enhancement are achieved.

### EXAMPLES 1 TO 3 AND COMPARATIVE EXAMPLES 1 TO 3

Hereinafter, explanations will be given on the results of an accelerated mold growing test on the disk-keeping bags having a configuration shown in the first embodiment related to the invention wherein the fibers for the non-woven fabric and the addition amount of the fungicide were changed individually.

As the procedures of the accelerated mold growing test, after kept in an atmosphere of 30° C. and 99% RH (Relative Humidity) for 2 weeks with use of an environmental testing apparatus, each sample prepared in a testing mode was returned to an ambient temperature environment (23° C. and 50% RH), and kept there for 3 days; then, the occurrence of foreign matter was evaluated by observing the disk surface. The observation was carried out by the naked eye and with an optical microscope under 200 times magnification. For the case where no foreign matter was recognized, symbol O was assigned. For the case where the occurrence of foreign matter was recognized, symbol X was assigned. Identification of the foreign matter as mold or not was conducted by configurational comparison with separately prepared mold specimens, a comparison with use of an FTIR (Fourier Transform Infra-Red Spectrometer), etc.

Just to make sure, the impregnation of the fungicide was conducted by dissolving the above-cited 3-iodo-2-propynyl-N-butylcarbamate in cyclohexane, and spaying the resulting solution directly onto the non-woven fabric. The addition amount of the fungicide was determined by drying the non-woven fabric after solution spraying and quantitatively analyzing the remaining fungicide by means of liquid chromatography.

The results of the above-described accelerated mold growing test are shown in Table 1.

TABLE 1

| | | | | Added Amount | | |
|---|---|---|---|---|---|---|
| | | Added Amount of | | of Fungicided | | |
| | Fiber of | Fungicide in | | in Sheet | Result of | Quility |
| | Non-Woven | Non-Woven | Sheet | Material in | Mold Growing | Change in |
| | Fabric | Fabric in wt % | Material | wt % | Test | Disk surface |
| Example 1 | PET/PP Mixed | 0.5 | PP | None | ◯ | None |
| | Yarn 50%/50% | | | | | |
| Example 2 | Rayon/PET Mixed | 0.5 | PP | None | ◯ | None |
| | Yarn 50%/50% | | | | | |
| Example 3 | PET/PP Mixed Yarn | 0.5 | PP | 0.5 | ◯ | None |
| | 50%/50% | | | | | |
| Comparative | Rayon/PET Mixed | 0.05 | PP | None | X | None |
| Example 1 | Yarn 50%/50% | | | | | |
| Comparative | Rayon/PET Mixed | 1.2 | PP | None | ◯ | Transfer of |
| Example 2 | Yarn 50%/50% | | | | | |
| Comparative | PET/PP Mixed Yarn | None | PP | None | X | None |
| Example 3 | 50%/50% | | | | | |

In the sample of Example 1, which is a disk-keeping bag according to the invention, the non-woven fabric was made of a mixture of 50% PET and 50% PP (polypropylene) fibers incorporated with 0.5 wt % of the fungicide. And the resinous sheet consisted of PP with no fungicide added. The sample of Example 2 is the same as the one of Example 1 except that the non-woven fabric consisted of a mixture of 50% rayon and 50% PET fibers. The sample of Example 3 is the same as the one of Example 1 except that the resinous sheet was one incorporated with 0.5 wt % of the fungicide.

As the result of the accelerated mold growing test for the samples of Examples 1 to 3, no mold growth was recognized for all the samples, and no quality change in the disk surface was observed.

On the other hand, in Comparative Example 1 in which the non-woven fabric was made of a mixture of 50% rayon and 50% PET fibers and incorporated with 0.05 wt % of the fungicide, and in which the PP resinous sheet was incorporated with no fungicide, mold grew because of the shortage of the addition amount of the fungicide.

Further, in Comparative Example 2 in which the non-woven fabric consisted of a mixture of 50% rayon and 50% PET fibers incorporated with 1.2 wt % of the fungicide while no fungicide was added to the PP resin sheet, no mold growth was observed but the fungicide was transferred onto the disk surface since the added amount of the fungicide was too large.

Still further, in Comparative Example 3 in which the non-woven fabric consisted of a mixture of 50% PET and 50% PP fibers with no fungicide added while any fungicide was not added to the PP resinous sheet, too, mold growth occurred due to the absence of the fungicide, though no quality change in the disk surface due to the fungicide was observed.

Various kinds of mold grew including blue and red ones. But, specifically, Asperigillus Niger, which is sometimes called koji-mold and is one of mycobacteria, and the like grew relatively easily.

### EXAMPLES 4 TO 6 AND COMPARATIVE EXAMPLES 4 TO 6

Hereinafter, explanations will be given on the results of an accelerated mold growing test on the disk-keeping bags for disk-formed recording media according to the first embodiment related to the invention wherein the non-woven fabric fibers and the resinous sheet material were changed individually.

As the procedures of the accelerated mold growing test, after kept in an atmosphere of 30° C. and 99% RH (Relative Humidity) for 2 weeks with use of an environmental testing apparatus, each sample prepared in a testing mode was returned to an ambient temperature atmosphere (23° C. and 50% RH), and kept there for 3 days; then, the occurrence of foreign matter was evaluated by observing the disk surface. The observation was carried out by the naked eye and with an optical microscope under 200 times magnification. For the case where no foreign matter was recognized, symbol O was assigned. For the case where the occurrence of foreign matter was recognized, symbol X was assigned. Further, depending on the size of the foreign matter occurrence, the samples were evaluated by assigning symbol A or XX. Identification of the foreign matter as mold or not was conducted by configurational comparison with separately prepared mold specimens, a comparison with use of FTIR (Fourier Transform Infra-Red Spectrometer), etc.

For the preparation of the non-woven fabrics used in the following Examples and Comparative Examples, a thermal bonding method was adopted wherein cotton, etc. having a low melting point was blended in the fabric fibers, said low melting point-fibers being melted by means of a hot press or hot air to fix and bond the fabric fibers together.

The results of the above-described accelerated mold growing test are shown in Table 2.

TABLE 2

| | | | Result of | |
|---|---|---|---|---|
| | Fiber of Non-Woven | | Mold growing | Area of Mold |
| | Fabric | Sheet Material | test | Occurrence |
| Example 4 | Acrylic 100% | Polypropylene | ∘ | None |
| Example 5 | Acrylic/PET Mixed | Polypropylene | ∘ | None |
| | Fiber 50%/50% | | | |
| Example 6 | Acrylic/PET Mixed | Acrylic | ∘ | None |
| | Fiber 50%/50% | | | |
| Comparative | PET 100% | Acrylic | Δ | Slight |
| Example 4 | | | | |
| Comparative | Acrylic/PET Mixed | Polypropylene | Δ | Slight |
| Example 5 | Fiber 40%/60% | | | |
| Comparative | Acrylic/PET Mixed | Polypropylene | X | Roughly Half |
| Example 6 | Fiber 10%/90% | | | |
| Comparative | Rayon/PET Mixed Fiber | Polypropylene | XX | Whole |
| Example 7 | 50%/50% | | | |

For all of the samples in Examples 4 to 6, which are disk-keeping bags of the invention, good fungicidal effects were achieved with no mold growth being recognized wherein in Example 4 the non-woven fabric was made of 100% acrylic fiber combined with a sheet material of propylene, in Example 5 the non-woven fabric consisted of the mixture of 50% acrylic and 50% PET (Poly(ethylene terephthalate)) fibers combined with the same sheet material as in Example 1, and in Example 6 the non-woven fabric was the same as in Example 5 combined with a sheet material of an acrylic-based resin. As has been confirmed herein, with those bags in which more than 50% of acrylic fiber is mixed, one could attain a sufficient fungicidal effect.

On the other hand, in Comparative Example 4 in which the non-woven fabric was made of 100% PET fiber combined with a sheet material of an acrylic-based resin, mold grew slightly. In this case, a weak fungicidal effect was achieved owing to the sheet material made of an acrylic-based resin, though no acrylic fiber was mixed in the non-woven fabric.

Further, in Comparative Example 5 in which the sheet material was the same as in Comparative Example 4 but the non-woven fabric was made of a mixture of 40% acrylic and 60% PET fibers, mold growth occurred slightly. As is shown here, the fungicidal effect weakens when the ratio of the acrylic fiber is below 50%.

Still further, in Comparative Example 6 in which the sheet material was the same as in Comparative Example 5 while the non-woven fabric consisted of a mixture of 10% acrylic and 90% PET fibers, mold growth occurred in almost half the disk plane area, indicating that with the decrease of the ratio of the acrylic fiber far below 50%, the fungicidal effect weakens synergistically.

In Comparative Example 7 in which the sheet material was the same as in Comparative Example 5 while the non-woven fabric consisted of 50% rayon and 50% PET fibers, mold grew in the whole area of the disk plane, showing that no fungicidal effect was attained.

Various kinds of molds grew including blue and red ones. But, in particular, Asperigillus Niger, which is sometimes called koji-mold and one of mycobacteria, and the like grew relatively easily.

According to the disk container of the invention, one can enhance the reliability of the disk container by suppressing mold growth specifically in the non-woven fabric portion, etc. which are regarded as the principal part for mold growth, and enabling the prevention of mold growth in the disk recording medium itself and the infection to other portions thereof.

The entire disclosure of each and every foreign patent application from which the benefit of foreign priority has been claimed in the present application is incorporated herein by reference, as if fully set forth.

What is claimed is:

1. A disk container for accommodating a disk recording medium, wherein at least one of (1) a non-woven fabric below and (2) a non-woven fabric below is provided at least on the interior surface of the disk container, the interior surface being at the side that comes into contact with the recording plane of the disk recording medium:
a non-woven fabric (1): a non-woven fabric impregnated with a solution containing C₄H₉NHCOOCH₂C≡CI (3-iodo-2-propynyl-N-butylcarbamate) in such a manner that the non-woven fabric contains C₄H₉NHCOOCH₂C≡CI in an amount of from 0.1 to 0.9 wt %,
a non-woven fabric (2): a non-woven fabric containing an acrylic fiber in an amount of 50 wt % or more.

2. A disk container for accommodating a disk recording medium, which comprises an acrylic-based resin.

3. The disk container for accommodating a disk recording medium according to claim 1 or 2, wherein the disc container is a bag for keeping disk.

4. The disk container for accommodating a disk recording medium according to claim 2, which comprises: a resin layer containing the acrylic-based resin; and a resin layer containing a resin other than the acrylic-based resin.

5. The disk container for accommodating a disk recording medium according to claim 2, wherein the angular portion of the component including the resin layer containing the acrylic-based resin are rounded out.

6. The disk container for accommodating a disk recording medium according to claim 2, which comprises: a case body; a lid; and a tray fitted in the case body, wherein the tray contains the acrylic-based resin.

7. A disk container for accommodating a disk recording medium, which comprises a synthetic resin mixed with an antifungal agent.

8. The disk container for accommodating a disk recording medium according to claim 7, which comprises: a resin layer containing a acrylic-based resin; and a resin layer containing the antifungal agent.
